(19) United States
(12) Patent Application Publication
(10) Pub. No.: US 2017/0147125 A1
(43) Pub. Date: May 25, 2017

(54) METHODS AND DEVICES FOR DETECTING INTENDED TOUCH ACTION

(71) Applicant: Xiaomi Inc., Beijing (CN)

(72) Inventors: Kun Yang, Beijing (CN); Jun Tao, Beijing (CN); Zhongsheng Jiang, Beijing (CN)

(73) Assignee: Xiaomi Inc., Beijing (CN)

(21) Appl. No.: 15/163,478

(22) Filed: May 24, 2016

(30) Foreign Application Priority Data
Nov. 25, 2015 (CN) 2015108291245

(51) Int. Cl. G06F 3/041; G06F 3/0346; G06F 3/0488

(52) U.S. Cl. CPC G06F 3/0416; G06F 3/04883; G06F 3/0346

(57) ABSTRACT

Methods and devices are disclosed for determining that a touch gesture is validly detected. In one embodiment, a method for detecting the touch gesture comprises: generating by a first sensing unit a first sensing parameter upon a touch action on the touch input interface; determining by the first sensing unit a first touch gesture corresponding to the first sensing parameter; acquiring by the first sensing unit a second touch gesture corresponding to a second sensing parameter generated by a second sensing unit; and determining that the touch gesture has been detected and is valid by confirming that the first touch gesture and the second touch gesture are the same; wherein the first and second sensing units are interconnected and are respectively one and the other of a touch control processor for the touch input interface and a motion sensor. With the combination of two sensors and checking the correspondence between touch gestures detected by the two sensors, the accuracy of detecting a valid touch gesture may be improved.

### CROSS-REFERENCE TO RELATED APPLICATIONS

This application is based upon and claims the priority of the Chinese patent application No. 2015108291245 filed on Nov. 25, 2015, which is incorporated herein by reference in its entirety.

### TECHNICAL FIELD

The present disclosure relates to the field of electronic equipment and particularly to methods and devices for determining a touch gesture on a touch input interface.

### BACKGROUND

Touch screens reduce usage restrictions to enhance user experience and expand device functions, and hence are widely used in electronic equipment. In actual use, the electronic device identifies the user's touch gesture through a touch screen and performs an operation corresponding to the touch gesture. However, for an accidental touch action occurred during carrying and transport of the device, the touch screen may tend to identify it as an intended touch gesture by a user. Therefore, only by touch screen alone, valid touch gesture may not be accurately identified.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, a method for detecting a touch gesture on a device having a touch input interface is provided. The method comprises: generating by a first sensing unit a first sensing parameter upon a touch action on the touch input interface; determining by the first sensing unit a first touch gesture corresponding to the first sensing parameter; acquiring by the first sensing unit a second touch gesture corresponding to a second sensing parameter generated by a second sensing unit; and determining that the touch gesture has been detected and is valid by confirming that the first touch gesture and the second touch gesture are the same, wherein the first and second sensing units are interconnected and are respectively one and the other of a touch control processor for the touch input interface and a motion sensor for the device.

In another embodiment, a device for detecting a touch gesture is disclosed. The device comprises: a touch input interface; a first sensing unit comprising one of a touch processor connected to the touch input interface and a motion sensor for the device; and a second sensing unit connected to the first sensing unit and comprising the other of the touch processor and the motion sensor, wherein the first sensing unit is configured to: generate a first sensing parameter upon detecting a touch action on the touch input interface; determine a first touch gesture corresponding to the first sensing parameter; acquire a second touch gesture corresponding to a second sensing parameter generated by a second sensing unit; and determine that the touch gesture has been detected and is valid by confirming that the first touch gesture and the second touch gesture are the same.

In yet another embodiment, a non-transitory computer-readable storage medium is disclosed. The storage medium has stored therein instructions that, when executed by a processor of a mobile terminal, causes the mobile terminal to: generate by a first sensing unit a first sensing parameter upon a touch action on a touch input interface connected to the first sensing unit; determine by the first sensing unit a first touch gesture corresponding to the first sensing parameter; acquire by the first sensing unit a second touch gesture corresponding to a second sensing parameter generated by a second sensing unit; and determine that the touch gesture has been detected and is valid by confirming that the first touch gesture and the second touch gesture are the same, wherein the first and second sensing units are interconnected and are respectively one and the other of a touch control processor for the touch input interface and a motion sensor.

### BRIEF DESCRIPTION OF THE DRAWINGS

The accompanying drawings, incorporated as part of this specification, illustrate embodiments consistent with the invention and, together with the description, serve to explain the principles of the invention.

FIGS. 1A-1B are schematic diagrams showing an electronic device, according to some exemplary embodiments;

FIG. 2 is a flow chart showing a method for determining a touch gesture, according to an exemplary embodiment;

FIG. 3A is a flow chart showing a method for determining a touch gesture, according to another exemplary embodiment;

FIG. 3B is a flow chart showing a method for determining a touch gesture, according to yet another exemplary embodiment;

FIG. 4A is a block diagram showing a device for determining a touch gesture, according to an exemplary embodiment;

FIG. 4B is a block diagram showing another device for determining a touch gesture, according to an exemplary embodiment; and

FIG. 5 is a block diagram showing yet another device for determining a touch gesture, according to an exemplary embodiment.

### DETAILED DESCRIPTION

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

The terminology used in the description of the disclosure herein is for the purpose of describing particular examples only and is not intended to be limiting of the disclosure. As used in the description of the disclosure and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

The methods, devices, and modules described herein may be implemented in many different ways and as hardware, software or in different combinations of hardware and software. For example, all or parts of the implementations may be a processing circuitry that includes an instruction processor, such as a central processing unit (CPU), microcontroller, a microprocessor; or application specific integrated circuits (ASICs), digital signal processors (DSPs), digital signal processing devices (DSPDs), programmable logic devices (PLDs), field programmable gate arrays (FPGAs), controllers, micro-controllers, microprocessors, other electronic components; or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Subject matter will now be described in more detail hereinafter with reference to the accompanying drawings in which the same numbers in different drawings represent the same or similar elements unless otherwise represented. The drawings form a part hereof, and show, by way of illustration, specific exemplary embodiments. Subject matter may, however, be embodied in a variety of different forms and, therefore, covered or claimed subject matter is intended to be construed as not being limited to any exemplary embodiments set forth herein. A reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

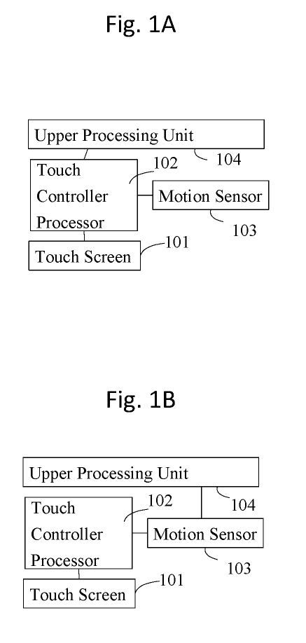

FIG. 1A is a schematic diagram showing an electronic device, according to an exemplary embodiment. As shown in FIG. 1A, the electronic device comprises a touch screen 101, a touch controller processor 102, a motion sensor 103, and an upper processing unit 104.

The touch screen 101 is connected with the touch controller processor 102. Upon a touch action by, for example, a fingertip of a user, the touch screen 101 of the electronic device generates a signal corresponding to the touch action that can be converted into a sensing parameter. The sensing parameter may be one or more detectable properties of the touch action including but not limited to touch contact length, contact time, swipe direction, swipe speed, and touch pressure. Each touch action is associated with a particular touch gesture which may be derivable from the sensing parameter detected by the touch screen.

The touch controller processor 102 is connected to the touch screen 101, the upper processing unit 104 and the motion sensor 103. The touch controller processor 102 may receive the signal and sensing parameter from the touch screen 101 (or alternatively, receive the signal from the touch screen and convert it to a sensing parameter) and process the parameter to determine the corresponding touch gesture. As will be shown later, the touch controller processor may also receive information from the motion sensor 103.

The motion sensor 103 is connected to the touch controller processor 102. The motion sensor 103 senses a motion of the device and collect a motion parameter of the electronic device, including one or more of motion characteristics including but not limited to linear speed, acceleration, an angular speed.

The upper processing unit 104 is connected to the touch controller processor 102 to further process the data results reported by the touch controller processor 102. In particular, the upper processing unit 104 rather than the touch controller processor may be responsible for determining touch gestures from the sensing parameters generated by the touch screen 101 and/or the motion sensor 103.

A parameter generated by either the touch screen/touch controller processer or the motion sensor is referred to as a sensing parameter herein. A parameter, in singular from, is not limited to a single sensed characteristic. It may include a collection of characteristics. For example, a sensing parameter from the touch screen/touch controller processer may include one or more of the touch characteristics described above. A sensing parameter from the motion sensor, likewise, may include one or more of the motion characteristics described above.

In addition, any “connection” referred to above and hereinafter may be wired connection, wireless connection, or any communications channel providing information transfer between two units, two modules or two chips which are “connected” with each other.

FIG. 1B is a schematic diagram showing another electronic device, according to another exemplary embodiment. As shown in FIG. 1B, the electronic device comprises the touch screen 101, the touch controller processor 102, the motion sensor 103 and the upper processing unit 104, similar to the embodiment of FIG. 1A The functions described above for these components applies. The connectivity between the components, however, is different between FIGS. 1B and 1A.

In FIG. 1B, the touch screen 101 is connected to the touch controller processor 102. The touch screen 101 of the electronic device generates a touch signal and a sensing parameter corresponding to the touch gesture when being touched, similar to FIG. 1A. The touch controller processor 102 is connected to the touch screen 101 and the motion sensor 103, respectively. The motion sensor 103 is connected to the touch controller processor 102 and the upper processing unit 104 to collect a motion parameter of the electronic device. The upper processing unit 104 is connected to the motion sensor 103 to further process the data results reported by the motion sensor 103. Thus, in FIG. B, the motion sensor is the unit that receives a touch parameter or the corresponding touch gesture determined by the touch screen/touch controller processor. In addition, the motion sensor rather than the touch controller processor is the unit that reports information to the upper processing unit when the upper processing unit is used to process the sensing parameters and determine the touch gesture.

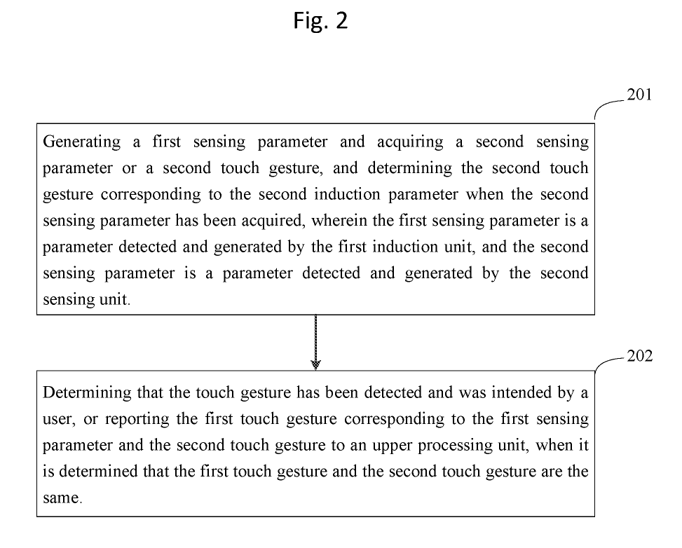

FIG. 2 is a flow chart showing a method for determining a touch gesture, according to an exemplary embodiment. As shown in FIG. 2, the method for determining the touch gesture is carried out in a first sensing unit. The first sensing unit here may be the touch screen and the touch controller processor combination shown in FIG. 1A or the motion sensor shown in FIG. 1B.

In step 201, the first sensing unit generates a first sensing parameter. It also acquires a second sensing parameter or alternatively acquires directly a second touch gesture. When the second sensing parameter rather than the second touch gesture is acquired, the first sensing unit additionally determines the second touch gesture corresponding to the second sensing parameter. The first sensing parameter is a parameter generated by the first sensing unit, and the second sensing parameter is a parameter generated by a second sensing unit. The second sensing unit may be the motion sensor shown in FIG. 1A or the touchscreen and the touch controller processor shown in FIG. 1B.

In step 202, the first sensing unit determines that the touch gesture has been detected and is valid (intended by the user and not accidental) when the first touch gesture corresponding to the first sensing parameter and the second touch gesture are determined to be the same touch gesture. The first sensing unit may alternatively reports the first touch gesture corresponding to the first sensing parameter and the second touch gesture to the upper processing unit of FIG. 1A or 1B.

To summarize, with respect to the method for determining the touch gesture in the embodiment of FIG. 2 in the present disclosure, the touch gesture of a user is determined by the combination of the first touch gesture corresponding to the first sensing parameter and the second touch gesture corresponding to the second sensing parameter and particularly by the combination of the outputs of the touch controller processor and the motion sensor. Such a combination improves the accuracy of identifying touch gestures intended by the user, and effectively reduce the probability of false determination of accidental touch events caused during, for example, carrying and transport of the device. The first sensing unit may additionally acquire the second sensing parameter from the second sensing unit. According to the first sensing parameter and the second sensing parameter, the first sensing unit may determine whether a touch gesture was intended by the user and determine what touch gesture was intended. Processing the sensing parameters within the first sensing unit saves the processing resource of the upper processing unit.

The first sensing unit in the above embodiments is one of the touch screen/touch controller processor and the motion sensor. The second sensing unit is the other one of the touch screen/touch controller processor and the motion sensor. The first sensing unit is connected with the second sensing unit in ways described in FIG. 1 such that the second sensing parameter may communicate with the first sensing unit. When the first sensing unit is the touch screen/touch controller processor and the second sensing unit is the motion sensor, the first sensing parameter is correspondingly a touch parameter generated when the touch screen connected to the touch controller processor is touched, and the second sensing parameter is correspondingly a motion parameter generated when the motion sensor detects a motion of the electronic device. Alternatively, when the first sensing unit is the motion sensor and the second sensing unit is the touch screen/touch controller processor, the first sensing parameter is correspondingly the motion parameter generated when the motion sensor detects the motion of the electronic device, and the second sensing parameter is correspondingly the touch parameter generated when the touch screen connected to the touch controller processor is touched.

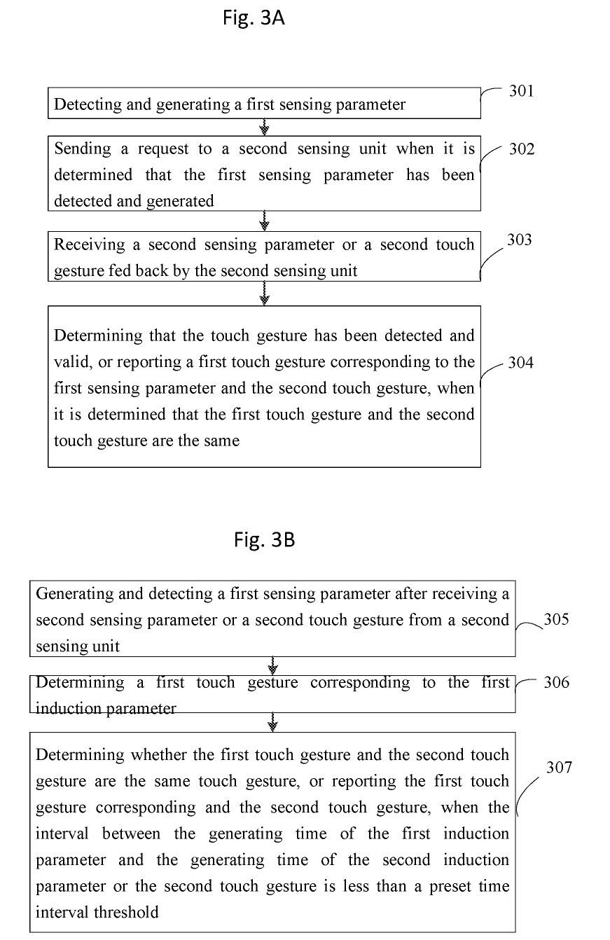

Depending on the causal relationship between generating the first sensing parameter and acquiring the second sensing parameter or the second touch gesture, the method of FIG. 2 may be implemented in at least two different embodiments shown in FIGS. 3A and 3B. In a first possible embodiment, as illustrated in the flow chart of FIG. 3A, after generating the first sensing parameter by the first sensing unit, the first sensing unit may actively send a request to the second sensing unit for the second sensing parameter or the second touch gesture sensed by the second sensing unit.

In step 301, the first sensing unit generates the first sensing parameter. For example, if the first sensing unit is the touch screen/touch controller processor combination, it generates a touch signal corresponding to a touch gesture when the touch screen is touched, and correspondingly generates a touch parameter as the first sensing parameter. Generally speaking, when the first sensing parameter is detected and generated, the first sensing unit may determine that a valid touch gesture is intended by a user at this time. However, to avoid detecting accidental and thus false touch and to more accurately determine an intended touch gesture, the first sensing unit may further execute step 302-304.

In step 302, the first sensing unit sends a request to the second sensing unit after the first sensing parameter has been detected and generated. The detection and generation of the first sensing parameter indicates that there may be an intended touch gesture. To further confirm whether the touch gesture is valid and intended, a request may be sent to the second sensing unit, to actively acquire the second sensing parameter from the second sensing unit, or to actively acquire the touch gesture determined by the second sensing unit according to the second sensing parameter generated by the second sensing unit. The request is thus configured to trigger the second sensing unit to feed back the second sensing parameter or the second touch gesture. Upon receiving the request sent by the first sensing unit, the second sensing unit correspondingly feeds back either the second sensing parameter or the second touch gesture corresponding to the second sensing parameter. The following gives an exemplary implementation of the step 302 of the embodiment above. Again, assume but not place any limitation in this example that the first sensing unit is the touch screen/touch controller processor combination while the second sensing unit is the motion sensor. After the touch screen/touch controller processor detects and generates the touch parameter (the first sensing parameter), it sends a request to the motion sensor. After receiving the request, the motion sensor feeds back the motion parameter to the touch controller processor or determines and then feeds back the second touch gesture corresponding to the motion parameter.

Optionally, when the first sensing unit detects and generates the first sensing parameter, request for the second sensing parameter or the second touch gesture may be sent to the second sensing unit upon determining by the first sensing unit that there exists the first touch gesture corresponding to the first sensing parameter. That is, the first sensing unit first determines that there exists a recognizable touch gesture according to the detected first sensing parameter before sending the request to the second sensing unit.

In the step 302 of the embodiment above, to ensure that the first sensing unit timely senses the first sensing parameter as it occurs, the first sensing unit may be set to a normally on state. The first sensing unit under the normally on state is kept in an operating state and is ready to sense the first sensing parameter as it occurs. To reduce the power consumption of the second sensing unit, the second sensing unit may, on the other hand, be set to be under a normally off state. The second sensing unit under the normally off state is kept under a non-operating state but capable of entering into an operating state promptly when waken up by the first sensing unit. The first sensing unit may wake up the second sensing unit by sending the request to the second sensing unit for the second sensing parameter or the second touch gesture. Or, before sending the request to the second sensing unit, the first sensing unit may first wake up the second sensing unit and then send the request to the already awoken second sensing unit.

In step 303, the first sensing unit receives the second sensing parameter or the second touch gesture fed back by the second sensing unit. Specifically, after receiving the request from the first sensing unit, the second sensing unit may feedback the sensed second sensing parameter. Or, after determining that there exists a recognizable second touch gesture corresponding to the second sensing parameter, the second sensing unit may send the second touch gesture to the first sensing unit. Accordingly, the first sensing unit may receive the second sensing parameter or the second touch gesture fed back by the second sensing unit. Particularly, assume again that the first sensing unit is the touch screen/touch controller processor combination while the second sensing unit is the motion sensor. After receiving the request from the touch controller processor, the motion sensor may directly feedback the sensed motion parameter (that is, the second sensing parameter) to the touch controller processor. Or after determining by the motion sensor that there exists a recognizable second touch gesture corresponding to the motion parameter, the motion sensor sends the second touch gesture to the touch controller processor. Accordingly, the touch controller processor receives the motion parameter or the second touch gesture.

When the second sensing unit feeds back the second sensing parameter rather than the second touch gesture to the first sensing unit, the first sensing unit, besides determining the first touch gesture corresponding to the first sensing parameter, may also determine the second touch gesture corresponding to the second sensing parameter received from the second sensing unit. For example, when the motion sensor feeds back the motion parameter to the touch controller processor, the touch controller processor not only may determine the first touch gesture according to the touch parameter but also determine the second touch gesture corresponding to the motion parameter.

In step 304, it is determined that an actionable and valid touch gesture has been detected and is intended by the user, when the first touch gesture corresponding to the first sensing parameter and the second touch gesture are determined to be the same touch gesture. Specifically, the first sensing unit may determine the first touch gesture corresponding to the first sensing parameter. If the first sensing unit in step 303 acquires the second sensing parameter rather than the second touch gesture, first sensing unit may further determines the second touch gesture corresponding to the second sensing parameter. The first sensing unit may then determine whether the first touch gesture and the second touch gesture are the same touch gesture. If they are the same touch gesture, an actionable and valid touch gesture is determined to be detected and was intended by the user. The first sensing unit may alternatively report to the upper processing unit the first touch gesture corresponding to the first sensing parameter and the second touch gesture.

In one embodiment, the determination of the first touch gesture corresponding to the first sensing parameter is based on a correspondence relation between a plurality of sensing parameters and a predetermined set of recognizable touch gestures. The correspondence relationship may be a lookup table stored in a memory connected to the sensing units. It may alternatively be embodied in an algorithm implemented by software, firmware or hardware. The input of the algorithm is the sensing parameters and the output would be one of the set of predetermined touch gestures if recognizable. The determination of the second touch gesture by either the second or the first sensing unit is implemented under similar principle and based on a correspondence relation between a plurality of second sensing parameters and a predetermined set of touch gestures.

Specifically each touch action may correspond to one touch gesture. A touch action, for example, may be a certain swiping action on the touch screen of a device by a user. The touch screen detects the swiping action and generates a detected sensing parameter for the swiping action. As discussed earlier, a sensing parameter for a touch action from the touch screen may include one or more of characteristics such as swipe direction, swipe speed, and swipe length. A touch gesture is a more categorical description of the intended touch action, such as fast swipe left to right, slow swipe top to bottom, double click, etc. A touch gesture thus corresponds to the range, speed, acceleration, direction and other characteristics of the swiping action. Further, a touch action on the touch screen may also cause the device to move relative to a floor, a table and other reference objects to a certain extent such that the motion sensor configured to sense the motion of the device may detect such motions and generates a motion parameter. A motion parameter, as discussed earlier, may include characteristics such as angle, speed, acceleration, motion range, and motion direction of the device relative to the floors, tables and other reference objects. A touch action on the touch screen may cause a motion of the device because for a typical user, a touch action on the touch screen by one hand often leads to some coordinated motion of the device held by the other hand of the user. Thus, the touch gesture corresponding to the detected swiping action on the touch screen and the typical coordinated motion of the device are interrelated.

As a result, correspondence between a set of touch gesture, touch parameters, and motion parameters may be established, by for example, statistical analysis of swiping actions of a user. A general model may be used to establish some initial correspondence relationship and then tuned for a particular user of the device (for example, owner of a mobile terminal) using some learning algorithm during the actual use of the device by a particular user. The correspondence relationship between touch gestures, touch parameters, and motion parameters may be stored in a look up table, or may be programed into an algorithm. When in actual use in the embodiments above, according to this pre-established correspondence relation, the first sensing unit may determine the first touch gesture based on the first sensing parameter and the second touch gesture based on the second sensing parameter. Alternatively, the first sensing unit may determine the first touch gesture based on the first sensing parameter and the second sensing unit may determine the second touch gesture based on the second sensing parameter and send it to the first sensing unit. Finally, the first sensing unit may determine whether the first and second touch gestures are the same touch gesture.

In one embodiment, the algorithm for determining the first touch gesture from the first sensing parameter by the first sensing unit may include a classifier of touch gestures. After inputting the first sensing parameter into the classifier, the first sensing unit obtains an output from the classifier, and determines a recognizable touch gesture corresponding to the first sensing parameter according to the corresponding relation between outputs of the classifier and a predetermined set of touch gestures. Similarly, the first sensing unit may input the second sensing parameter into the classifier, obtains an output from the classifier, and determine the second touch gesture corresponding to the second sensing parameter according to the corresponding relation between outputs of the classifier and a predetermined set of touch gestures. Alternatively, the second sensing unit may determine the second touch gesture based on the classifier in similar way and communicate the second touch gesture to the first sensing unit.

In an actual application, as the motion sensor may be very sensitive, a motion parameter (either the first or second sensing parameter) may be generated even if there is slight unintended motion or vibration of the device. Thus, by utilizing detection by both the touch controller processor and the motion sensor which detect sensing parameters within a same time period and corresponding to the same touch gesture, the determination accuracy of intended touch gesture may be improved. Therefore, before determining whether the first touch gesture and the second touch gesture are the same touch gesture, the first sensing unit may additionally determine the time interval between the generating time of the first sensing parameter and the generating time of the second sensing parameter or the second touch gesture. The first sensing unit may compare the interval to a predetermined time interval threshold. If the interval is greater than the threshold, the detected touch actions are regarded as unintended. The time interval threshold here may be predetermined based on typical maximal time lag between the occurrence and detection of the first and second sensing parameters corresponding to a same touch action. For example, the time interval threshold may be defined to be 0.2s. Only when the time interval between the generating time of the first sensing parameter and the generating time of the second sensing parameter or the second touch gesture is less than the predetermined time interval threshold, the first sensing unit may determine that the first and second touch gestures may be potentially the same, and proceed to actually determine whether the first touch gesture and the second touch gesture are the same touch gesture based on the correspondence relationship between touch gestures and touch parameters discussed above, or proceed to report the first touch gesture and the second touch gesture to the upper processing unit.

For example, when the interval between the generating time of the first sensing parameter and the generating time of the second sensing parameter or the second touch gesture corresponding to the second sensing parameter is less than the predetermined time interval threshold (for example, 0.2s), the first sensing unit determines whether the first touch gesture corresponding to the first sensing parameter and the second touch gesture corresponding to the second sensing parameter are the same touch gesture. Alternatively, the first sensing unit may report the first touch gesture corresponding to the first sensing parameter and the second touch gesture corresponding to the second sensing parameter to the upper processing unit. The upper processing unit may then determine whether the first touch gesture and the second touch gesture are the same touch gesture and conduct other relevant processing.

In the embodiments above, the predetermined time interval threshold may be further configured to encompass the time difference between the detection and processing by the first sensing unit and the second sensing unit of the same touch action. Specifically, the motion sensor and the touch controller processor may sense and process the first and second sensing parameters associated with the same touch action with some small time difference. For example, touch controller processor may generate the touch parameter later by 0.3ms than that of the motion sensor. The predetermined time interval threshold may be adjusted to be large enough to compensate for this detection and processing time difference such that the sensing units do not miss valid touch action that are detected and processed by the first and second sensing units with slight time lags.

In some cases, successive rather than simultaneous touch actions and device motions may be associated with one touch gesture. For example, in the case that the user swipes the screen of a mobile phone to unlock it after the user takes out the mobile phone from his/her pocket, there is a large-amplitude motion during the time the mobile phone is taken out followed by a user touch of the screen within 1-2 seconds. That is, the touch controller processor may be configured to correlate the touch action on the screen with the taking out motion that precedes the touch action for 1-2 second and associate them with the same swipe gesture. In some other cases, the touch action and a device motion may be approximately simultaneous. For example, if the user clicks the screen while holding the mobile phone, the mobile phone may also have slight simultaneous shake.

In one embodiment, some motions detected by the motion sensor outside a predetermined range may be ignored and thus no motion parameter may be measured. Consequently, no corresponding touch gestures and no intended touch gesture by a user may need to be determined. Specifically, the motion sensor may be very sensitive and may detect motions unrelated to any actual touch action. Ignoring these motions help save processing resources of the device in acquiring the motion parameter, communicating and processing it. Only the motions within the predetermined range may be further measured and processed. The predetermined range may be characterized by an upper threshold and lower threshold, for example, in motion speed or motion range. A detected motion outside the two threshold range may indicate either the detected motion is noise or the device is under external disturbance that is too great to be a characteristic of device motion caused by a typical touch action by a user. Examples of motions of the device that is too great to be associated with a touch action includes but are not limited to dropping of the device, collision of the device with other objects, carrying and transport of the device. These motions may be ignored by the sensing units.

More complicated touch gestures may be detected with improved accuracy using the principles discussed above. For example, when the user double-clicks the screen, the first touch gesture may be determined to be double click on the screen by the user according to a sensing parameter with the characteristic that two touches are successively carried out at the same position within a small area. Then the motion parameter within the predetermined time interval is acquired. If two successive motion is detected within the time period, and the time of the successive motion and the time when the touch controller processor collects the double click action agree within the predetermined time interval threshold, and the device motion is within the predetermined motion range, it may be determined that a valid and intended double click gesture is detected.

In the above context, if the maximum detected range of the motion of the device is larger than the normal maximum range of motion corresponding to double click action on the screen (for example, the former maximum value is 100 times as much as the latter maximum value), the detected motion within the time period defined by the predetermined time interval most likely does not correspond to any double click action by the user. It may instead be caused by, for example, the mobile phone touching a human body twice during falling. The first touch gesture and the second touch gesture are not the same touch gesture. Therefore, the accidental touch may be excluded.

In a summary, with respect to the method for detecting the touch gesture provided in the embodiments above, the accuracy to identify the touch gesture may be improved by requesting the second sensing parameter from the second sensing unit, and determining whether the touch gesture was intended on the basis of the combination of determining the first touch gesture corresponding to the first sensing parameter and determining the second touch gesture corresponding to the second sensing parameter after the first sensing unit acquires the first sensing parameter.

With respect to the method for determining the touch gesture provided by the embodiment above, only when the time interval between the generating time of the first sensing parameter and the generating time of the second sensing parameter or the second touch gesture corresponding to the second sensing parameter is less than the predetermined time interval threshold, is it determined whether the first touch gesture and the second touch gesture are the same. As such, false determination of accidental touch events caused, for example, during carrying and transport of the device may be reduced.

Those of ordinary skill in the art understand that it is merely exemplary that the above embodiments assume that the first sensing unit is the touch screen/touch controller processor and the second sensing unit is the motion sensor. In an actual application, the first sensing unit may be the motion sensor. Accordingly, the second sensing unit may the touch screen/touch controller processor combination. The principles described above apply equally to the latter case.

Again, depending on the causal relationship between generating the first sensing parameter and acquiring the second sensing parameter or the second touch gesture, the method of FIG. 2 may be implemented in at least two different embodiments. The first possible embodiment was illustrated in FIG. 3A and described in detail above. The second embodiment is illustrated by the flow chart in FIG. 3B and will be described below. In this embodiment, after acquiring the second sensing parameter, the second sensing unit may actively report the sensed second sensing parameter or the second touch gesture determined by the second sensing parameter to the first sensing unit, rather than doing so on request from the first sensing unit. After receiving the second sensing parameter, the first sensing unit may determine the touch gesture (the second touch gesture) according to the parameter reported actively by the second sensing unit. Other principles described for FIG. 3A also apply to FIG. 3B.

In step 305, the first sensing unit generates the first sensing parameter after receiving the second sensing parameter or the second touch gesture sent by the second sensing unit. In one embodiment, once the second sensing parameter is detected, the second sensing unit sends the sensed second sensing parameter to the first sensing unit. Alternatively, upon sensing the second sensing parameter, the second sensing unit may first determine the second touch gesture corresponding to the second sensing parameter and send the determined second touch gesture to the first sensing unit. In other words, when receiving the second sensing parameter or the second touch gesture sent by the second sensing unit, the first sensing unit may determine that the second sensing unit senses some potential touch action. To determine using the combination of the information sensed by the second sensing unit and the first sensing unit, the first sensing unit may determine whether it can detect the first sensing parameter in response to the information sent by the second sensing unit.

Assume that the second sensing unit is the motion sensor and may thus be relatively sensitive and may sense slight movement of the electronic device. To decrease the unnecessary false detection and frequent unnecessary interaction between the first sensing unit and the second sensing unit, the second sensing unit may send the second sensing parameter to the first sensing unit only when it determines that the second sensing parameter corresponds to some touch gesture rather than noise or other motion such as dropping of the device. Thus, after acquiring the second sensing parameter, the second sensing unit may determine whether the second sensing parameter corresponds to any touch gesture. If the second sensing parameter corresponds with a touch gesture, the second sensing parameter is sent to the first sensing unit.

In one embodiment, the second sensing unit may be set to be under a normally on state. The second sensing unit under the normally on state is kept to be an operating state and ready to sense the second sensing parameter in real time. To reduce the power consumption of the first sensing unit, the first sensing unit may be set to be under a normally off state. The first sensing unit under the normally off state is kept under a non-operating state, and enters into an operating state only when waken up by the second sensing unit and proceed to detect and generate the first sensing parameter. The first sensing unit may be waken up when the second sensing unit senses the second sensing parameter and reports the second touch gesture corresponding to the second sensing parameter to the first sensing unit. Alternatively, before reporting the sensed second sensing parameter or the second touch gesture corresponding to the second sensing parameter to the first sensing unit, the second sensing unit may first wake up the first sensing unit before sending the second sensing parameter or the second touch gesture.

In step 306, the first sensing unit determines the first touch gesture corresponding to the first sensing parameter. In one embodiment, the first sensing unit may determine the first touch gesture corresponding to the first sensing parameter according to the correspondence relation between first sensing parameters and the predetermined touch gestures. The first sensing unit may determine the second touch gesture corresponding to the second sensing parameter according to the corresponding relation between second sensing parameters and the predetermined touch gestures.

In another embodiment, the first sensing unit may use a predetermined algorithm including a classifier of the touch gestures, as described previously for FIG. 3A. After inputting the first sensing parameter into the classifier, the first sensing unit obtains an output value from the classifier, and determines the first touch gesture corresponding to the first sensing parameter according to the correspondence relation between the output of the classifier and the predetermined set of touch gestures. Similarly, if the first sensing unit receives the second sensing parameter reported by the second sensing unit, the first sensing unit may similarly input the second sensing parameter into the classifier, and determines the second touch gesture corresponding to the second sensing parameter according to the correspondence relation between the output of the classifier and the a set of predetermined touch gestures.

In step 307, When the time interval between the generating time of the first sensing parameter and the generating time of the second sensing parameter or the second touch gesture is less than a predetermined time interval threshold, the first sensing unit may determine whether the first touch gesture corresponding to the first sensing parameter and the second touch gesture are the same touch gesture. Alternatively, the first sensing unit may report the first touch gesture corresponding to the first sensing parameter and the second touch gesture to the upper processing unit.

Similar to the embodiment in FIG. 3A, the motion sensor may be very sensitive to the motion of the electronic device. To avoid false determination caused by this sensitivity, the first sensing unit may only considers the first sensing parameter and the second sensing parameter or the second touch gesture detected and processed within the approximately same time period, or alternatively, only considers the first touch gesture and the second touch gesture detected within approximately the same time period. Thus, only when the interval between the generating time of the first sensing parameter and the generating time of the second sensing parameter/the second touch gesture is less than the predetermined time interval threshold, the first sensing unit determines whether the first touch gesture corresponding to the first sensing parameter and the second touch gesture are the same touch gesture or reports the first touch gesture corresponding to the first sensing parameter and the second touch gesture. The predetermined time interval threshold here is similar to the predetermined time interval discussed in the embodiment shown in FIG. 3A.

To summarize briefly here, with respect to the method for determining the touch gesture provided in the embodiment of FIG. 3B, the accuracy to identify the touch gesture may be improved by detecting the first touch gesture corresponding to the first sensing parameter after detecting the second touch gesture corresponding to the second sensing parameter. In addition, only when the interval between the generating time of the first sensing parameter and the generating time of the second sensing parameter or the second touch gesture corresponding to the second sensing parameter is less than the predetermined time interval threshold does the first sensing unit proceed to determine whether the first touch gesture and the second touch gesture are the same gesture. As such, false determination of unrelated first and second touch gestures as the same touch gesture intended by a user may be avoided.

In the above embodiments, it may be assumed as an example that the first sensing unit is the touch screen/touch controller processor and the second sensing unit is the motion sensor. Those skilled in the art understand that in an actual application, the first sensing unit may be the motion sensor while the second sensing unit may be the touch screen/touch controller processor. In the latter case, the touch controller processor rather than the motion sensor may actively report the touch parameter or the corresponding second touch gesture to the motion sensor. The motion sensor then detects the motion parameter, acquires the first touch gesture corresponding to the motion parameter, and determines whether the first and second touch gestures are the same touch gesture. The detailed process is similar to that described in the embodiments of FIG. 3A. The relevant description of FIG. 3A applies to FIG. 3B.

In the embodiments above, determine whether the first and second touch gestures are the same touch gesture is carried out in the first sensing unit rather than distributed to both the first and second sensing units. Less communication between the sensing units is required. As such, processing efficiency may be improved.

The following described various embodiments of a device for carrying out the methods of the present disclosure. For details not described below in the device embodiments, description for FIGS. 1-3 applies.

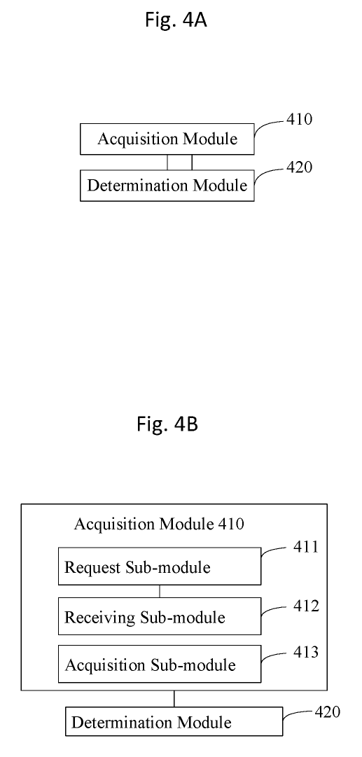

FIG. 4A is a block diagram showing a device for determining a touch gesture, according to an exemplary embodiment. As shown in FIG. 4A, the device for determining the touch gesture is used for the touch controller processor or the motion sensor shown in FIG. 1A and FIG. 1B. The device for determining the touch gesture comprises the acquisition module 410 and the determination module 420.

The acquisition module 410 is configured to detect, generate, or acquire the first sensing parameter and the second sensing parameter or the second touch gesture, and determine the second touch gesture corresponding to the second sensing parameter. The first sensing parameter is a parameter generated and detected by the first sensing unit, and the second sensing parameter is a parameter generated and detected by the second sensing unit.

The determining module 420 is configured to determine the touch gesture as a valid touch gesture intended by a user has been detected, or to report the first touch gesture corresponding to the first sensing parameter and the second touch gesture to the upper processing unit, when the first and second touch gestures are determined to be the same touch gesture. The first sensing unit is one of the touch screen/touch controller processor and the motion sensor. The second sensing unit is the other one of the touch screen/touch controller processor and the motion sensor.

In one embodiment, the determination module 420 is configured to determine whether a touch gesture exist within a predetermined set of touch gestures that corresponds to the first sensing parameter and whether it is the same as the second touch gesture, or report the first touch gesture corresponding to the first sensing parameter and the second touch gesture to the upper processing unit, when the time interval between the generating time of the first sensing parameter and the generating time of the second sensing parameter/the second touch gesture is less than the predetermined time interval threshold.

FIG. 4B shows a block diagram of a device for determining a touch gesture according to another exemplary embodiment. The device comprises the acquisition module 410 and determination module 420. The acquisition module 410 further comprises a request sub-module 411 and a receiving sub-module 412.

The request sub-module 411 is configured to send request to the second sensing unit when the first sensing unit determines that the first sensing parameter has been generated. The request is configured to trigger the second sensing unit to feed back the second sensing parameter or the second touch gesture. The receiving sub-module 412 is configured to receive the second sensing parameter or the second touch gesture fed back by the second sensing unit. In some embodiment, the acquisition sub-module 411 is configured to send the request to the second sensing unit when it is determined that the first sensing parameter has been generated, and in addition, that there exists a first touch gesture corresponding to the first sensing parameter.

In some embodiment, as shown by FIG. 4B, the acquisition module 410 may further comprise an acquisition sub-module 413. The acquisition sub-module 413 is configured to detect and generate the first sensing parameter after receiving the second sensing parameter or the second touch gesture sent by the second sensing unit. In a specific embodiment, the acquisition sub-module 413 is configured to receive the second sensing parameter which is sent only when the second sensing unit determines that there exists the second touch gesture corresponding to the second sensing parameter.

In the embodiments above, the first sensing unit is one of the touch screen/touch controller processor and the motion sensor. The second sensing unit is the other one of the touch screen/touch controller processor and the motion sensor. When the first sensing unit is the touch screen/touch controller processor and the second sensing unit is the motion sensor, the first sensing parameter is a touch parameter generated when the touch screen touched, and the second sensing parameter is a motion parameter generated when the motion sensor detects the motion of the electronic device. Alternatively, when the first sensing unit is the motion sensor and the second sensing unit is the touch screen/touch controller processor, the first sensing parameter is the motion parameter generated when the motion sensor detects the motion of the electronic device, and the second sensing parameter is the touch parameter generated when the touch screen is touched.

In a summary, with respect to the device for determining the touch gesture provided in the embodiments above, the accuracy to identify the touch gesture intended by a user may be improved by requesting the second sensing parameter from the second sensing unit, and determining on the basis of the combination of the first touch gesture corresponding to the first sensing parameter and the second touch gesture corresponding to the second sensing parameter.

With respect to the device for determining the touch gesture provided by some of the embodiments of the present disclosure, only when the interval between the generating time of the first sensing parameter and the generating time of the second sensing parameter or the second touch gesture corresponding to the second sensing parameter is less than the predetermined time interval threshold, does the first sensing unit proceed to determine whether the first touch gesture and the second touch gesture are the same gesture, so as to reducing the possibility of regarding accidental touch events during carrying and transport of device as intended touches by the user.

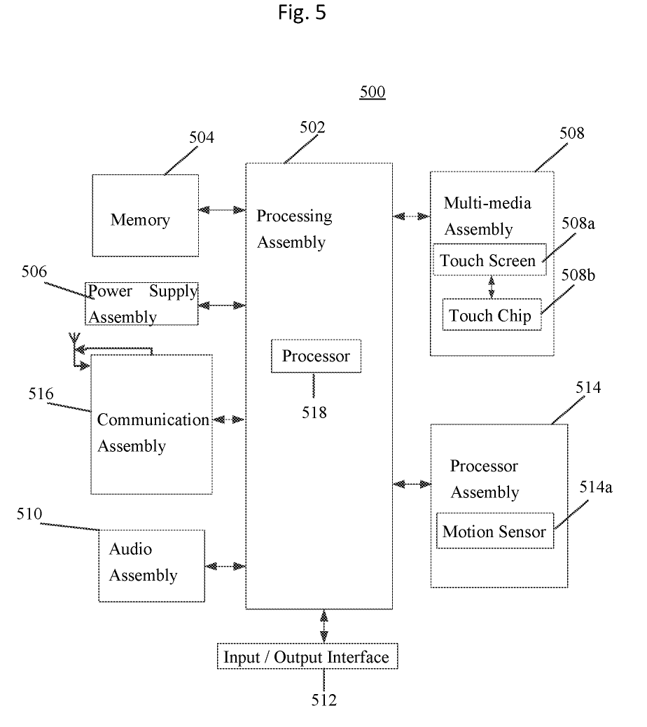

FIG. 5 is a block diagram showing a device for determining a touch gesture, according to an exemplary embodiment. The device 500 may be a mobile phone, the computer, a digital broadcast terminal, a messaging apparatus, a game console, a tablet apparatus, a medical apparatus, a fitness apparatus, a personal digital assistant, etc. The device 500 may include one or more of the following assemblies: a processing assembly 502, a memory 504, a power supply assembly 506, a multimedia assembly 508, an audio assembly 510, an input/output (I/O) interface 512, a sensor assembly 514, and a communications assembly 516.

The processing assembly 502 generally controls the whole operations of the device 500 such as display, phone call, data communication, camera operation and record operation. The processing assembly 502 may include one or more processors 518 for executing instructions for all or part of the steps of the above methods. In addition, the processing component 502 may include one or more modules for controlling the interaction between the processing assembly 502 and other assemblies. For example, the processing assembly 502 may include a multimedia module for controlling the interaction between the media assembly 508 and the processing assembly 502.

The memory 504 is configured to store various types of data to support the operation of the device 500. Examples of these data include but are not limited to executable instructions for any application or operating system, contact data, address book data, massages, pictures, and videos. The memory 504 may be implemented in any physical form. It may be a volatile storage, non-volatile storage, or combination thereof. It may be Static Random Access Memory (SRAM), Electrically-Erasable Programmable Read Only Memory (EEPROM), Erasable Programmable Read Only Memory (EPROM), Programmable Read Only Memory (PROM), Read Only Memory (ROM), a magnetic memory, a flash memory, a magnetic disk, or an optical disk.

The power supply assembly 506 provides power to various assemblies of the device 500. The power supply assembly 506 may include a power supply management system, one or more power supplies, and other assemblies for generating, managing and distributing electricity to the device 500.

The multimedia component 508 includes a display screen providing an output interface between the device 500 and the user. In some embodiments, the screen may be a Liquid Crystal Display (LCD). It may include a Touch Panel (TP). If the screen includes the touch panel, the screen may be implemented as a touch screen 508a to receive an input signal from the user. The touch screen 508a may be connected to a touch controller processor 508b. The touch controller processor 508b processes the signal from the touch screen. The touch panel includes one or more touch sensors to sense the gestures of user touching and swiping the touch panel. The touch sensor may detect the range of touch or swiping gesture. It may also detect the time duration and pressure of the touch or swiping action. In some embodiments, the media assembly 508 includes one front-facing camera and/or one rear-facing camera. When the device 500 is in an operation mode (for example, a shooting mode or a video mode), the front-facing camera and/or the rear-facing camera may record videos or images. Each of the front-facing camera and the rear-facing camera may be a fixed optical lens system or may have adjustable focal length and ability to zoom.

The audio component 510 is configured to output and/or input an audio signal. For example, the audio assembly 510 may include one microphone (MIC). When the device 500 is under the operation mode (for example, a calling mode, a record mode or a speech recognition mode), the microphone may be configured to receive the audio signal from outside. The received audio signal may be further stored in the memory 504 or sent via the communication assembly 516. In some embodiments, the audio assembly 510 may also include a speaker configured to output the audio signal.

The I/O interface 512 provides an interface between the processing assembly 502 and a peripheral interface module. The peripheral interface module may be one or more keyboards, click wheels, and buttons. These buttons may include but are not limited to a home button, a volume button, a starting button and a locking button.

The sensor assembly 514 may include one or more sensors and is configured to provide various status of the device 500. For example, the sensor assembly 514 may detect the opening/closing state of the device 500, and relative positioning of the assembly. The sensor assembly 514 may further detect the motion of the device 500 or the motion of one or more of the assemblies of the device 500. The sensor assembly 514 may also detect the existence or non-existence of physical contact between the user and the device 500. It may detect the orientation, acceleration/deceleration, and temperature of the device 500. The sensor assembly 514 may include proximity sensors configured to detect the presence of an adjacent object even when there is no any physical contact. The sensor assembly 514 may also include optical sensors (such as CMOS or a CCD image sensor) configured for imaging applications. In some embodiments, the sensor assembly 514 may also include motion sensors, such as acceleration sensors, gyros as well as other types of sensors, such as magnetic sensors, pressure sensors or thermometers.

The communication module 516 is configured to facilitate wired or wireless communication between the device 500 and other apparatuses. The device 500 may access the wireless network based on a communication standard, such as WiFi, 2Gcellular, 3G cellular, LTE, 4G cellular, or the combination thereof. In one exemplary embodiment, the communication assembly 516 receives a broadcast signal from an external broadcast management system via a broadcast channel. In one exemplary embodiment, the communication assembly 516 may also include a Near Field Communication (NFC) module, to facilitate short-range communication. For example, the NFC module may be implemented based on Radio Frequency Identification (RFID) technology, Infrared Data Association (IrDA) technology, Ultra-Wideband (UWB) technology, Bluetooth (BT) technology and other technologies.

In an exemplary embodiment, the device 500 may be implemented by one or more Application Specific Integrated Circuits (ASIC), a Digital Signal Processor (DSP), a Digital Signal Processing Device (DSPD), a Programmable Logic Device (PLD), a Field Programmable Gate Array (FPGA), a controller, a microcontroller, a microprocessor, or other electronic components.

Each module or unit discussed above for FIG. 4, such as the acquisition module, determination module, request sub-module, receiving sub-module, and acquisition sub-module, may take the form of a packaged functional hardware unit designed for use with other components, a portion of a program code (e.g., software or firmware) executable by the processor 518 or the processing circuitry that usually performs a particular function of related functions, or a self-contained hardware or software component that interfaces with a larger system, for example.

In an exemplary embodiment, a non-transitory computer-readable storage medium comprising instructions is also provided. The instructions may be executed by the processor 518 of the device 500 to implement the methods described above. The non-transitory computer-readable storage medium may be a ROM, a random access memory (RAM), a CD-ROM, a magnetic tape, a floppy disk, an optical data storage devices and the like.

The illustrations of the embodiments described herein are intended to provide a general understanding of the structure of the various embodiments. The illustrations are not intended to serve as a complete description of all of the elements and features of apparatus and systems that utilize the structures or methods described herein. Other embodiments of the disclosure will be apparent to those skilled in the art from consideration of the specification and practice of the embodiments disclosed herein. This application is intended to cover any variations, uses, or adaptations of the disclosure following the general principles thereof and including such departures from the present disclosure as come within known or customary practice in the art. It is intended that the specification and examples are considered as exemplary only, with a true scope and spirit of the invention being indicated by the following claims in addition to the disclosure.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method for detecting a touch action intended by a user on a device having a touch input interface, comprising:
generating by a first sensing unit a first sensing parameter upon a touch action on the touch input interface;
determining by the first sensing unit a first touch gesture corresponding to the first sensing parameter;
acquiring by the first sensing unit a second touch gesture corresponding to a second sensing parameter generated by a second sensing unit; and
determining that the touch action has been detected and is valid by confirming that the first touch gesture and the second touch gesture are the same,
wherein the first and second sensing units are in communication with each other;
wherein the first sensing unit is one of a touch sensing unit or a motion sensing unit for the device; and
wherein the second sensing unit is another of the touch sensing unit or the motion sensing unit.

2. The method according to claim 1, wherein the touch sensing unit is a touch controller processor for the touch input interface.

3. The method according to claim 1, wherein acquiring by the first sensing unit the second touch gesture corresponding to the second sensing parameter generated by the second sensing unit comprises:
in response to the generation of the first sensing parameter, sending a request by the first sensing unit to the second sensing unit for triggering the second sensing unit to send the second sensing parameter to the first sensing unit;
receiving by the first sensing unit the second parameter; and
determining by the first sensing unit the second touch gesture according to the second sensing parameter.

4. The method according to claim 3, wherein the request by the first sensing unit to the second sensing unit is further in response to the determination by the first sensing unit of the first touch gesture corresponding to the first sensing parameter.

5. The method according to claim 1, wherein acquiring by the first sensing unit the second touch gesture corresponding to the second sensing parameter comprises:
in response to the generation of the first sensing parameter, sending a request by the first sensing unit to the second sensing unit for triggering the second sensing unit to send the second touch gesture to the first sensing unit; and
receiving by the first sensing unit the second touch gesture.

6. The method according to claim 5, wherein sending the request by the first sensing unit to the second sensing unit is further in response to the determination by the first sensing unit of the first touch gesture corresponding to the first sensing parameter.

7. The method according to claim 1, wherein generating by the first sensing unit the first sensing parameter is in response to acquiring the second touch gesture corresponding to the second sensing parameter generated by the second sensing unit.

8. The method according to claim 1, wherein acquiring by the first sensing unit the second touch gesture corresponding to the second sensing parameter comprises:
receiving by the first sensing unit the second sensing parameter sent by the second sensing unit; and
determining the second touch gesture by the first sensing unit according to the received second sensing parameter, and
wherein generating by the first sensing unit the first sensing parameter is in response to receiving by the first sensing unit the second sensing parameter sent by the second sensing unit.

9. The method according to claim 8, wherein receiving by the first sensing unit the second sensing parameter sent by the second sensing unit is conditioned on the second sensing unit determining that there exists the second touch gesture corresponding to the second sensing parameter.

10. The method according to claim 1, wherein confirming that the first touch gesture and the second touch gesture are the same is conditioned on a time interval between a generating time of the first sensing parameter by the first sensing unit and a generating time of the second sensing parameter by the second sensing unit being less than a predetermined time interval threshold.

11. The method according to claim 1, wherein the first sensing parameter and the second sensing parameter are each of a different one of a touch parameter generated when a touch screen connected to the touch controller processor is touched or a motion parameter generated when the motion sensor detects a motion of the device.

12. A device for detecting a intended touch action, comprising:
a touch input interface;
a first sensing unit comprising one of a touch processor in communication with the touch input interface or a motion sensor for the device; and
a second sensing unit connected to the first sensing unit and comprising another of the touch processor or the motion sensor,
wherein the first sensing unit is configured to:
generate a first sensing parameter upon detecting a touch action on the touch input interface;
determine a first touch gesture corresponding to the first sensing parameter;
acquire a second touch gesture corresponding to a second sensing parameter generated by the second sensing unit; and
determine that the touch gesture has been detected and is valid in response to confirming that the first touch gesture and the second touch gesture are the same.

13. The device for detecting the touch action according to claim 12, wherein, to acquire the second touch gesture corresponding to the second sensing parameter generated by a second sensing unit, the first sensing unit is configured to:
send, in response to the generation of the first sensing parameter, a request to the second sensing unit for triggering the second sensing unit to send the second sensing parameter;
receive the requested second sensing parameter; and
determine the second touch gesture corresponding to the second sensing parameter.

14. The device for detecting the touch action according to claim 13, wherein sending the request by the first sensing unit to the second sensing unit is in response to the determination by the first sensing unit of the first touch gesture corresponding to the first sensing parameter.

15. The device for detecting the touch gesture according to claim 12, wherein, in acquiring the second touch gesture corresponding to the second sensing parameter generated by a second sensing unit, the first sensing unit is configured to:
in response to the generation of the first sensing parameter, send a request by the first sensing unit to the second sensing unit for triggering the second sensing unit to feed back the second touch gesture to the first sensing unit; and
receive by the first sensing unit the second touch gesture.

16. The device for detecting the touch action according to claim 15, wherein sending the request by the first sensing unit to the second sensing unit is further in response to the determination by the first sensing unit of the first touch gesture corresponding to the first sensing parameter.

17. The device for detecting a touch action according to claim 12, wherein when generating the first sensing parameter upon detecting a touch action, the first sensing unit is configured to detect the touch action and generate the first sensing parameter in response to the acquiring of the second touch gesture corresponding to the second sensing parameter generated by the second sensing unit.

18. The device for detecting the touch action according to claim 12, wherein the first sensing unit,
to acquire the second touch gesture corresponding to the second sensing parameter generated by the second sensing unit, is configured to:
receive the second sensing parameter sent by the second sensing unit; and
determine the second touch gesture according to the received second sensing parameter, and
to generate the first sensing parameter, is configured to:
generate the first sensing parameter in response to receiving by the first sensing unit the second sensing parameter sent by the second sensing unit.

19. The device for detecting the touch action according to claim 18, wherein to receive the second sensing parameter sent by the second sensing unit, is conditioned on the second sensing unit determining that there exists the second touch gesture corresponding to the second sensing parameter.

20. The device for detecting the touch action according to claim 12, wherein confirming that the first touch gesture and the second touch gesture are the same is conditioned on a time interval between a generating time of the first sensing parameter by the first sending unit and a generating time of the second sensing parameter by the second sensing unit being less than a predetermined time interval threshold.

21. The device for detecting the touch action according to claim 12, wherein the first sensing parameter and the second sensing parameter are a different one of a touch parameter generated when the touch input interface connected to the touch controller processor is touched or a motion parameter generated when the motion sensor detects a motion of the device.

22. A non-transitory computer-readable storage medium having stored therein instructions that, when executed by a processor of a mobile terminal, causes the mobile terminal to:
generate by a first sensing unit a first sensing parameter upon a touch action on a touch input interface connected to the first sensing unit;
determine by the first sensing unit a first touch gesture corresponding to the first sensing parameter;
acquire by the first sensing unit a second touch gesture corresponding to a second sensing parameter generated by a second sensing units; and
determine that the touch action has been detected and is valid by confirming that the first touch gesture and the second touch gesture are the same;
wherein the first and second sensing units are in communication with one another and are respectively one or the other of a touch controller processor for the touch input interface or a motion sensor.
